(19) United States
(12) Patent Application Publication
(10) Pub. No.: US 2003/0198870 A1
(43) Pub. Date: Oct. 23, 2003

(54) Electrolytic composition and non-aqueous electrolytic secondary battery

(75) Inventors: Koji Wariishi, Kanagawa (JP); Michio Ono, Kanagawa (JP)

Correspondence Address: BURNS, DOANE, SWECKER & MATHIS L.L.P., P.O. Box 1404, Alexandria, VA, 22313-1404, US

(73) Assignee: FUJI PHOTO FILM CO., LTD.

(21) Appl. No.: 10/374,075

(22) Filed: Feb. 27, 2003

(30) Foreign Application Priority Data
Feb. 27, 2002 (JP) 2002-51865

(51) Int. Cl. H01M 10/40; H01M 4/50; H01M 4/52; H01M 4/58

(52) U.S. Cl. 429/313; 429/317; 429/231.1; 429/231.3; 429/223; 429/224; 429/231.8

(57) ABSTRACT

The present invention provides an electrolytic composition including a silicon polymer having a specific formula, inorganic fine particles and a metal ion salt of the 1st or 2nd group of the periodic table, as well as a non-aqueous electrolytic secondary battery including the electrolytic composition.

### BACKGROUND OF THE INVENTION

1. Field of the Invention

The present invention relates to an electrolytic composition, and more particularly to an electrolytic composition suitable for an antistatic agent, a material used in a battery or in other electrochemical devices, as well as to a non-aqueous electrolytic secondary battery with a high capacity and an excellent cycle stability.

2. Description of the Related Art

An electrolyte used in an electrochemical battery such as a non-aqueous electrolytic secondary battery is a medium, which includes ions in accordance with an object and has a function of transporting such ions between electrodes (ionic conduction). For example, in a lithium secondary battery, which is a representative non-aqueous electrolytic secondary battery, the electrolyte is a medium having a function of transporting lithium ions between the electrodes.

In these batteries, a solution system electrolyte having a high ionic conductivity is often used, but the solution system electrolyte has a drawback in that when incorporated in a battery, the durability of the battery is lowered by depletion of the electrolyte owing to a high volatility of a solvent or by leakage of the electrolyte owing to its fluidity. Further, in order to keep the solution in the battery without leakage, it is necessary to use a metal container, leading to an increased weight of the battery and a restricted freedom in the shape of the battery.

In order to solve the aforementioned drawbacks of the solution system electrolyte, solidification of the electrolyte has recently been investigated extensively. For example, a polymer electrolyte that is prepared by dissolving a salt in a polymer such as polyethylene oxide (PEO) is expected to solve the drawbacks of the solution system electrolyte, but such a polymer electrolyte has a problem in that an ionic conductivity and a transport number of the ions (lithium ions in case of a lithium secondary battery), which characteristics are required of the electrolyte, are reduced.

It is reported in Nature, 394, 456 (1998) that the ionic conductivity and the ion transport number are improved when inorganic fine particles of Al₂O₃, TiO₂ or the like are added to a polymer electrode that was prepared by dissolving LiClO₄ in PEO. The resultant electrolyte is, however, low in both the ionic conductivity and the ion transport number, and thus it is impossible to provide such electrolytes for practical use.

### SUMMARY OF THE INVENTION

The present invention has been made to solve the conventional drawbacks described above and aims to achieve the following. Specifically, it is an object of the invention to provide a novel and excellent electrolytic composition, which has a high ionic conductivity and a large ion transport number and shows low or no fluidity, as well as a non-aqueous electrolytic secondary battery that has a high battery capacity without causing a loss of its capacity, does not lose its capacity and exhibits good cycle stability.

The inventors have conducted intensive research in consideration of the foregoing and found that an electrolytic composition that was prepared by adding inorganic fine particles to a composition containing a silicon polymer and a metal ion salt of the 1st or 2nd group of the periodic table shows an excellent charge transporting ability and a good durability, to thus accomplish the present invention.

More specifically, the present invention can provide the following.

A first aspect of the invention is an electrolytic composition comprising a silicon polymer, inorganic fine particles and a metal ion salt of the 1st or 2nd group of the periodic table.

In the electrolytic composition, the silicon polymer preferably includes, as the repeating unit, a structure represented by the following general formula (1):

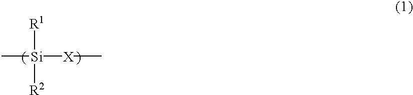

wherein R¹ and R² each represent an optionally substituted alkyl, alkoxy, aryl or aryloxy group; and X represents an oxygen atom, a nitrogen atom, an alkylene group, a phenylene group, a silicon atom, a metal atom or an atomic group in combination thereof.

A second aspect of the invention is a non-aqueous electrolytic secondary battery that has an anode and a cathode, and comprises an electrolytic composition containing a silicon polymer, inorganic fine particles and a metal ion salt of the 1st or 2nd group of the periodic table.

### BRIEF DESCRIPTION OF THE DRAWINGS

FIG. 1 is a cross-sectional view of a cylinder-shaped battery that is employed in an example.

FIG. 2 is a schematic view of a sheet-shaped battery that is employed in an example.

### DESCRIPTION OF THE PREFERRED EMBODIMENTS

Preferred embodiments of the present invention will be described in detail below.

An electrolytic composition and a non-aqueous electrolytic secondary battery of the present invention achieve reduced interfacial resistance and improved ionic conductivity, presumably because addition of inorganic fine particles to a specific polymer prevents crystallization of the polymer, and a silicon polymer used as the specific polymer has a higher compatibility with inorganic fine particles, particularly with fine silicon particles, than the PEO system has.

In the present invention, if the following requirements are fulfilled, the ion transport number and the ionic conductivity can be enhanced.

[1] Electrolytic Composition

The electrolytic composition of the present invention can be used for or in, e.g., a reaction solvent for a chemical reaction, a metal plating or the like, a CCD (charge-coupled device) camera, various batteries, a photo-electric converting element, a photosensor, or an image sensor (e.g., an electronic camera). Among these examples, the electrolyte is preferably used in a non-aqueous electrolytic secondary battery, particularly a lithium ion secondary battery.

Hereinafter, each of the components of the electrolytic composition of the invention will be described in detail.

(A) Silicon polymer

The electrolytic composition of the invention includes a silicon polymer.

The silicon polymer used in the invention means a polymer that includes in the side chain of a polymer skeleton an atomic group containing a silicon atom (e.g., poly(p-trimethylsilylstyrene) or poly(1-trimethylsilyl-1-propyne)) or a polymer that includes in the main chain of a polymer a silicon atom. Among these, a polymer including a silicon atom in the main chain of a polymer is prepared.

The polymer including silicon in the main chain of a polymer may preferably be a linear, branched, cyclic or polycyclic polymer that includes a structure represented by the general formula (1) shown above as the repeating unit.

In the general formula (1) above, R¹ and R² each represent an alkyl group, an alkoxy group, an aryl group or an aryloxy group, each of which may have a substituent.

In the general formula (1), the alkyl group represented by R¹ and R² may preferably be an alkyl group having 1 to 8 carbon atoms, such as a methyl group, an ethyl group, a linear or branched propyl, butyl, pentyl, hexyl, heptyl or octyl group, among which the more preferred is an alkyl group having 1 to 4 carbon atoms. A methyl group, an ethyl group, a propyl group, an n-butyl group, a t-butyl group or the like is particularly preferred from the standpoint of augmenting the effect of the invention.

In the general formula (1), the alkoxy group represented by R¹ and R² may preferably be an alkoxy group having 1 to 10 carbon atoms, such as a methoxy group, an ethoxy group, a linear or branched propoxy, butoxy, pentyloxy, hexyloxy, heptyloxy, octyloxy, nonyloxy or decyloxy group, among which the more preferred is an alkoxy group having 1 to 4 carbon atoms. Particularly preferred is a methoxy group, an ethoxy group, a propoxy group, an n-butoxy group or a t-butoxy group.

The aryl group represented by R¹ and R² may preferably be an aryl group having 1 to 10 carbon atoms, among which the more preferred is a phenyl group or a naphthyl group.

The aryloxy group represented by R¹ and R² may preferably be an aryloxy group having 6 to 20 carbon atoms, more preferably an aryloxy group having 6 to 10 carbon atoms, among which particularly preferred is a phenoxy group, a p-methylphenoxy group, p-methoxyphenoxy group or a naphthoxy group.

The above-described alkyl, alkoxy, aryl or aryloxy group represented by R¹ and R² may have a substituent. Preferred examples of the substituent are listed below.

Examples of the substituent include a halogen atom, an alkyl group, an aryl group, a heterocyclic group, a cyano group, a nitro group, an alkoxy group, a silyloxy group, an acyloxy group, a carbamoyloxy group, an alkoxycarbonyloxy group, an aryloxycarbonyloxy group, an amino group, an acylamino group, an aminocarbonylamino group, an alkoxycarbonylamino group, an aryloxycarbonylamino group, a sulfamoylamino group, an alkyl/aryl-sulfonylamino group, a mercapto group, an alkylthio group, an arylthio group, a heterocyclic thio group, a sulfamoyl group, an alkyl/aryl-sulfinyl group, an alkyl/aryl-sulfonyl group, an acyl group, an aryloxycarbonyl group, an alkoxycarbonyl group, a carbamoyl group and a silyl group.

Among these substituents, preferred halogen atoms are a chlorine atom, a bromine atom and an iodine atom.

The alkyl group may be a linear, branched or cyclic alkyl group. Preferred examples of the alkyl group include a methyl group, an ethyl group, an n-propyl group, an isopropyl group, a t-butyl group, an n-octyl group, an eicosyl group, a 2-chloroethyl group, a 2-cyanoethyl group, a 2-ethylhexyl group, a cyclohexyl group, a cyclopentyl group and a 4-n-dodecylcyclohexyl group.

Preferred examples of the aryl group include a phenyl group, a p-tolyl group, a naphthyl group and an m-chlorophenyl group.

The heterocyclic group may preferably be, for example, a monovalent group formed by removing a hydrogen atom from a 5- or 6-membered, substituted or non-substituted, aromatic or non-aromatic heterocyclic compound, among which the more preferred is a 2-furyl group, a 2-thienyl group, a 2-pyrimidinyl group, or a 2-benzothiazolyl group.

The alkoxy group may preferably be, for example, a methoxy group, an ethoxy group, an isopropoxy group, a t-butoxy group, an n-octyloxy group, a 2-methoxyethoxy group, or —O(CH₂CH₂O)ₙCH₃.

The silyloxy group may preferably be, for example, a trimethylsilyloxy group, a t-butyldimethylsilyloxy group, or a trimethoxysilyloxy group.

The acyloxy group may preferably be, for example, a formyloxy group, an acetyloxy group, a pivaloyloxy group, a stearoyloxy group, a benzoyloxy group, or a p-methoxyphenylcarbonyloxy group.

The carbamoyloxy group may preferably be, for example, an N,N-dimethylcarbamoyloxy group, an N,N-diethylcarbamoyloxy group, a morpholinocarbonyloxy group, an N,N-di-n-octylaminocarbonyloxy group, or an N-n-octylcarbamoyloxy group.

The alkoxycarbonyloxy group may preferably be, for example, a methoxycarbonyloxy group, an ethoxycarbonyloxy group, a t-butoxycarbonyloxy group, or an n-octylcarbonyloxy group.

The aryloxylcarbonyloxy group may preferably be, for example,

a phenoxycarbonyloxy group,

a p-methoxyphenoxycarbonyloxy group, or

a p-n-hexadecyloxyphenoxycarbonyloxy group.

The amino group may preferably be, for example, an amino group, a methylamino group, a dimethylamino group, an anilino group, an N-methyl-anilino group, or a diphenylamino group.

The acylamino group may preferably be, for example, a formylamino group, an acetylamino group, a pivaloylamino group, a lauroylamino group, a benzoylamino group, or a 3,4,5-tri-n-octyloxyphenylcarbonylamino group.

The aminocarbonylamino group may preferably be, for example, a carbamoylamino group, an N,N-dimethylaminocarbonylamino group, an N,N-diethylaminocarbonylamino group, or a morpholinocarbonylamino group.

The alkoxycarbonylamino group may preferably be, for example, a methoxycarbonylamino group, an ethoxycarbonylamino group, a t-butoxycarbonylamino group, an n-octadecyloxycarbonylamino group, or an N-methyl-methoxycarbonylamino group.

The aryloxycarbonylamino group may preferably be, for example,

a phenoxycarbonylamino group,

a p-chlorophenoxycarbonylamino group, or

an m-n-octyloxyphenoxycarbonylamino group.

The sulfamoylamino group may preferably be, for example, a

sulfamoylamino group,

an N,N-dimethylaminosulfonylamino group, or

an N-n-octylaminosulfonylamino group.

The alkyl/aryl-sulfonylamino group may preferably be, for example, a methylsulfonylamino group, a butylsulfonylamino group, a phenylsulfonylamino group, a 2,3,5-trichlorophenylsulfonylamino group, or a p-methylphenylsulfonylamino group.

The alkylthio group may preferably be, for example, a methylthio group, an ethylthio group, or an n-hexadecylthio group.

The arylthio group may preferably be, for example, a phenylthio group, a p-chlorophenylthio group, or an m-methoxyphenylthio group.

The heterocyclic thio group may preferably be, for example, a substituted or unsubstituted heterocyclic thio group having 2 to 30 carbon atoms, with a 2-benzothiazolyl group or a 1-phenyltetrazol-5-ylthio group being preferred.

The sulfamoyl group may preferably be, for example, an N-ethylsulfamoyl group, an N-(3-dodecyloxylpropyl)sulfamoyl group, an N,N-dimethylsulfamoyl group, an N-acetylsulfamoyl group, an N-benzoylsulfamoyl group, an N-(N′-phenylcarbamoyl)sulfamoyl group.

The alkyl/aryl-sulfinyl group may preferably be, for example, a methylsulfinyl group, an ethylsulfinyl group, a phenylsulfinyl group, or a p-methylphenylsulfinyl group.

The alkyl/aryl-sulfonyl group may preferably be, for example, a methylsulfonyl group, an ethylsulfonyl group, a phenylsulfonyl group, or a p-methylphenylsulfonyl group.

The acyl group may preferably be, for example, an acetyl group, a pivaloyl group, a 2-chloroacetyl group, a stearoyl group, a benzoyl group, or a p-n-octyloxyphenylcarbonyl group.

The aryloxycarbonyl group may preferably be, for example, a phenoxycarbonyl group, an o-chlorophenoxycarbonyl group, an m-nitrophenoxycarbonyl group, or a p-t-butylphenoxycarbonyl group.

The alkoxycarbonyl group may preferably be, for example, a methoxycarbonyl group, an ethoxycarbonyl group, a t-butoxycarbonyl group, or an n-octadecyloxycarbonyl group.

The carbamoyl group may preferably be, for example, a carbamoyl group, an N-methylcarbamoyl group, an N,N-dimethylcarbamoyl group, an N,N-di-n-octylcarbamoyl group, or an N-(methylsulfonyl)carbamoyl group.

The silyl group may preferably be, for example, a substituted or unsubstituted silyl group having 3 to 30 carbon atoms, with a trimethylsilyl group, a t-butyldimethylsilyl group or a phenyldimethylsilyl group being preferred.

In the general formula (1) shown above, X represents an oxygen atom, a nitrogen atom, an alkylene group, a phenylene group, a silicon atom, a metal atom or an atomic group in combination thereof.

Examples of the atomic group represented by X include polysiloxane, polysilazane, polysilmethylene, polysilphenylene, polysilane and polymetallosiloxane. An oxygen atom, or an atomic group comprising an oxygen atom and an alkylene group is preferred, and oxygen atom(s) is most preferred.

Among the polymers having the structure represented by the above general formula (1) as the repeating unit, the more preferred is a linear, branched, cyclic or polycyclic polymer having the repeating unit in which R² is an optionally substituted alkoxy or aryloxy group; and X is an oxygen atom. In this repeating unit, it is more preferred that R¹ is an alkoxy group. It is still more preferred that at least one of R¹ and R² has an alkoxycarbonyl group as the substituent, with the proviso that it is only the case where the substituent for R² is an alkoxy group or an aryloxy group.

The silicon polymer represented by the above general formula (1) preferably has an average molecular weight of 500 to 1,000,000, and more preferably of 500 to 500,000.

Specific examples of the silicon polymer of the present invention (A-1 to A-22), namely, the silicon polymers including the structure represented by the above general formula (1) as the repeating unit will be shown below, however, the present invention is not limited thereto.

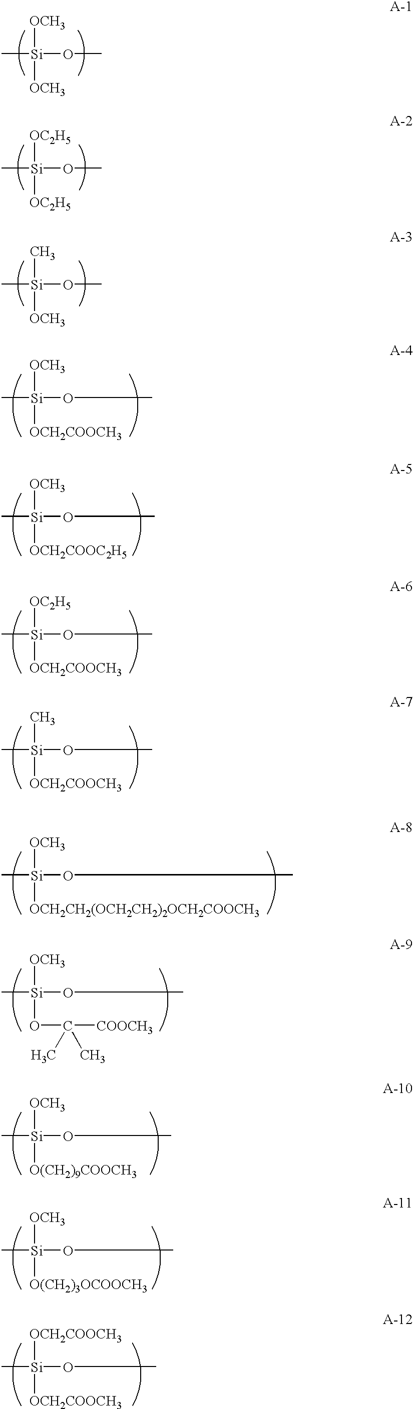

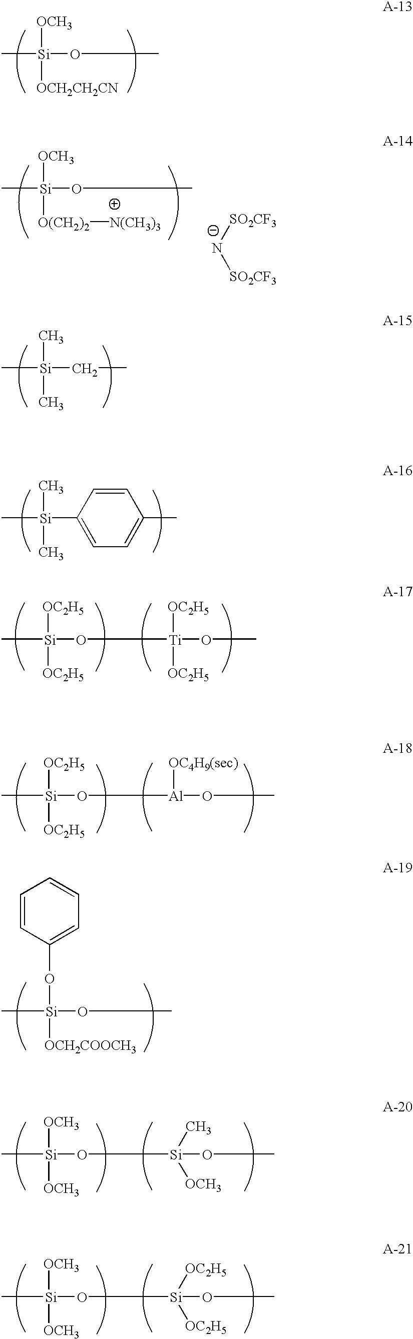

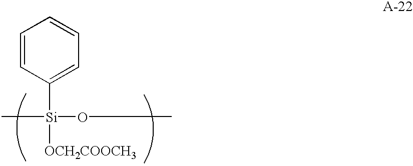

Preparation (synthesis) of the silicon polymer may readily be conducted according to the methods described in Jikken Kagaku Koza, 4^{th} Edition (edited by Chemical Society of Japan, Vol.28, p.371 (Maruzen Co.), Development of Organic Silicon Polymers (edited by Hideki Sakurai), p.245 (General version, CMC Co.), and Japanese Patent Application No. 2000-46723.

(B) Inorganic fine particles

Preferable examples of the inorganic fine particles used in the present invention include inorganic oxides such as silica (silicon oxide), aluminum oxide, zinc oxide, magnesium oxide and titanium oxide. Such inorganic fine particles may be employed in combination of two or more kinds thereof.

The inorganic fine particles have an average primary particle size preferably of 500 nm or less, more preferably 200 nm or less, and particularly preferably from 2 nm to 200 nm.

The inorganic fine particles may be crystalline or amorphous, or a mixture thereof.

The inorganic fine particles may be surface-treated, for example, with dimethylsilicone oil or a silane coupling agent. For example, in case of silica, the fine particles may be hydrophobic amorphous silica, obtained by treating the surface of amorphous silica, that is principally composed of silicon dioxide in the form of a powder, with a methyl group, an octylsilyl group or a trimethylsilyl group.

The inorganic fine particles are present in the electrolytic composition of the invention in a concentration (addition amount) of 0.1 to 100% by mass, more preferably 0.5 to 50% by mass, and particularly preferably 1 to 25% by mass, relative to the silicon polymer.

(C) Metal ion salt of 1st or 2nd group of periodic table

The electrolytic composition of the invention contains a metal ion salt of the 1 st or 2nd group of the periodic table, with a metal ion salt of the Ia or IIa group of the periodic table being preferred. Among the metal ions of the Ia or IIa group of the periodic table, the preferred is an ion of lithium, sodium or potassium. An anion for the metal ion salt may be, for example, a halide ion (e.g., I⁻, Cl⁻ or Br⁻), SCN⁻, BF₄⁻, PF₆⁻, ClO₄⁻, SbF₆⁻, (CF₃SO₂)₂N⁻, (CF₃CF₂SO₂)₂N⁻, Ph₄B⁻, (C₂H₄O₂)₂B⁻, (CF₃SO₂)₃C⁻, CF₃COO⁻, CF₃SO₃⁻, or C₆F₅SO₃⁻. Among these, the more preferred as the anion is SCN⁻, BF₄⁻, PF₆⁻, ClO₄⁻, SbF₆⁻, (CF₃SO₂)₂N⁻, (CF₃CF₂SO₂)₂N⁻, (CF₃SO₂)₃C⁻, or CF₃SO₃⁻.

Representative examples of the metal ion salt include LiCF₃SO₃, LiPF₆, LiClO₄, LiI, LiBF₄, LiCF₃CO₂, LiSCN, LiN(SO₂CF₃)₂, NaI, NaCF₃SO₃, NaClO₄, NaBF₄, NaAsF₆, KCF₃SO₃, KSCN, KPF₆, KClO₄ and KAsF₆. Lithium salts are more preferred. These compounds may be used singly or in combination of two or more kinds thereof.

The metal ion salt is present in the electrolytic composition of the invention in a concentration (addition amount) of preferably 1 to 300% by mass, and more preferably 3 to 200% by mass, relative to the silicon polymer.

(D) Fused salt

The fused salt contained in the electrolytic composition of the invention will be described.

The electrolytic composition of the invention may contain a salt having a low melting point, or so-called fused salt, from the standpoints of exhibiting a high ionic conductivity and a low volatility. The fused salt is preferably a compound which is a liquid at the normal temperature (about 25° C.), or so-called room temperature fused salt. Such a fused salt may be the compounds described in Yoyu-en to Ko-on Kagaku (Fused salt and high-temperature chemistry), Vol. 44, P.7 (2001) or Japanese Patent Application No. 2000-390909.

The fused salt is present in the electrolytic composition of the invention in a concentration (addition amount) preferably of 1 to 300% by mass, and more preferably 3 to 200% by mass, relative to the silicon polymer.

(E) Solvent

In the invention, a solvent may be used in an amount up to the same mass as the silicon polymer used, but it is not preferable to use solvents in view of storability.

The solvent used in the electrolytic composition of the invention is desirably a compound that has a low viscosity or a high dielectric constant and is capable of improving an effective carrier concentration by increasing an ion mobility, thereby achieving a high ionic conductivity. Examples of the solvent include carbonate compounds such as ethylene carbonate and propylene carbonate; heterocyclic compounds such as 3-methyl-2-oxazolidinone; ether compounds such as dioxane and diethyl ether; linear ethers such as ethylene glycol dialkyl ether, propylene glycol dialkyl ether, polyethylene glycol dialkyl ether and polypropylene glycol dialkyl ether; alcohols such as methanol, ethanol, ethylene glycol monoalkyl ether, propylene glycol monoalkyl ether, polyethylene glycol monoalkyl ether and polypropylene glycol monoalkyl ether; polyhydric alcohols such as ethylene glycol, propylene glycol, polyethylene glycol, polypropylene glycol and glycerin; nitrile compounds such as acetonitrile, glutarodinitrile, methoxyacetonitrile, propionitrile and penzonitrile; esters such as carboxylic acid ester, phosphoric acid ester and phosphonic acid ester; aprotic polar substances such as dimethyl sulfoxide and sulforan; and water. Among these, particularly preferred are carbonate compounds such as ethylene carbonate and propylene carbonate; heterocyclic compounds such as 3-methyl-2-oxazolidinone; nitrile compounds such as acetonitrile, glutarodinitrile, methoxy acetonitrile, propionitrile and benzonitrile; and esters. These compounds may be used singly or in combination of two or more kinds thereof.

From the standpoint of improving the durability from an evaporation resistance, the solvent preferably has a boiling point of 200° C. or higher at a normal temperature (1 atm), more preferably 250° C. or higher, and most preferably 270° C. or higher.

(F) Others The electrolytic composition of the invention may be used in a solidified state by causing crosslinking with a compound that includes at least two nucleophilic groups within a molecule (hereinafter such a compound may be simply called a nucleophilic agent). For example, when a nucleophilic agent is allowed to react with the specific compound of the invention, the alkoxy group in the side chain of the silicon polymer is easily substituted (to effect a substituting reaction), whereby a bond is formed between the silicon atom and the nucleophilic agent. When a nucleophilic agent having two or more nucleophilic groups is allowed to react with the silicon polymer, the polymer undergoes crosslinking to thus solidify the electrolytic composition.

The electrolytic composition is preferably used in a solidified state from the standpoint of preventing liquid leakage or evaporation.

The nucleophilic group contained in the nucleophilic agent is preferably a hydroxyl group, an amino group, a mercapto group, a sulfide group, a sulfino group or a sulfinato group, among which particularly preferred is a hydroxyl group. Specific examples of the nucleophilic agent are shown below, but the invention is not limited thereto.

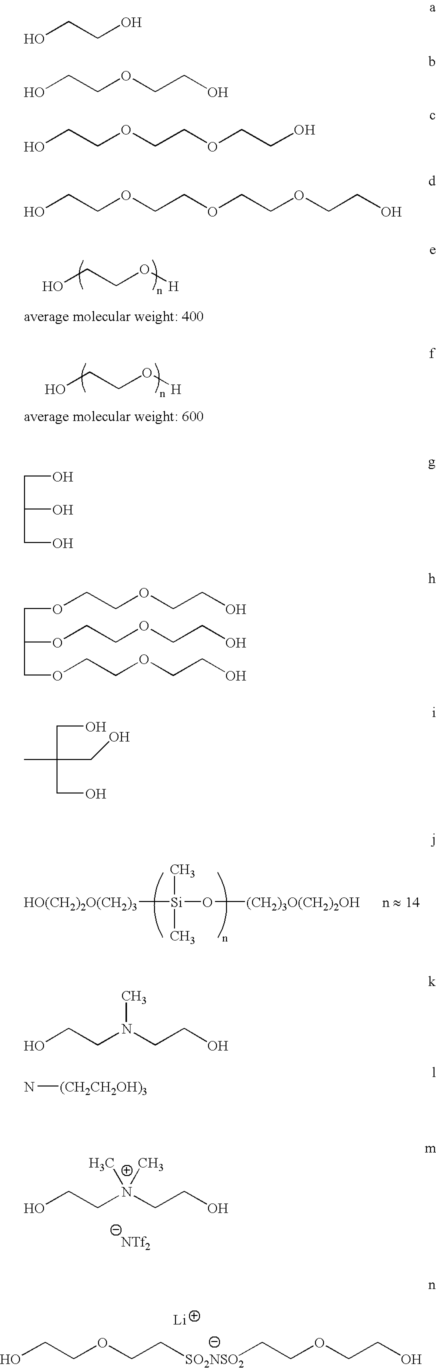

The nucleophilic agent is preferably added in an amount of 0.1 to 70% by mass, more preferably of 0.3 to 50% by mass, and particularly preferably of 0.5 to 30% by mass, relative to the silicon polymer. The reaction temperature when the nucleophilic agent is added preferably ranges from 0 to 150° C., and more preferably from 10 to 100° C. The reaction time of the nucleophilic agent is preferably from 5 minutes to 2 days, and more preferably from 10 minutes to 1 day. The reaction temperature and the reaction time are not particularly limited, but may be suitably selected depending on a desired reaction rate.

The electrolytic composition of the present invention may be used in a gelled (solidified) state employing a suitable method, such as an addition of a polymer, an addition of an oil gelling agent, polymerization of a polyfunctional monomer, or a polymer crosslinking reaction.

When gelling is effected by the addition of a polymer, there can be employed compounds described in Polymer Electrolyte Reviews-1 and -2 (co-edited by J. R. MacCallum and C. A. Vincent, ELSEVIER APPLIED SCIENCE). Particularly advantageously used is polyacrylonitrile, polyvinylidene fluoride, polyethylene oxide or polysiloxane.

When gelling is effected by the addition of an oil gelling agent, advantageously used are the compounds described in Kogyo Kagaku Zasshi (J. Chem. Soc. Japan, Ind. Chem. Sec.), 46, 779(1943), J. Am. Chem. Soc., 111, 5542 (1989), J. Chem. Soc., Chem. Commun., 1993, 390, Angew. Chem. Int. Ed. Engl., 35, 1949(1996), Chem. Lett., 1996, 885, and J. Chem. Soc., Chem. Commun., 1997, 545, among which the more preferred is a compound having an amide structure in the molecule.

(G) Preparation of electrolytic composition As described above, the silicon polymer can be prepared (synthesized) according to the methods described in Jikken Kagaku Koza, 4^{th} Edition (edited by Chemical Society of Japan, 28, p.371 (Maruzen Co.), Development of Organic Silicon Polymers (edited by Hideki Sakurai), p.245 (General version, CMC Co.), and Japanese Patent Application No. 2000-46723.

In the preparation of the electrolytic composition of the present invention, a step of preparing the silicon polymer and a step of adding, to the silicon polymer, the inorganic fine particles, the metal ion salt of the group 1 (Ia) or 2 (IIa) of the periodic table, and the fused salt or the solvent may be performed simultaneously; or alternatively, after the step of preparing the silicon polymer has been completed, the step of adding the inorganic fine particles, the metal ion salt and the fused salt or the solvent is carried out.

More specifically, the preparation of the silicon polymer may be conducted in the presence of the inorganic fine particles, the metal ion salt of the group 1 (Ia) or 2 (IIa) of the periodic table, the fused salt, the solvent or the like; or alternatively, the silicon polymer is prepared and then the addition of the inorganic fine particles, the metal ion salt, the fused salt and the solvent later to the silicon polymer is carried out.

[2] Non-Aqueous Electrolytic Secondary Battery

Next, a secondary battery in which the electrolytic composition of the present invention is preferably used will be described. The secondary battery of the invention comprises a layered product made of an anode sheet and a cathode sheet with a gap therebetween, and the gap is filled with the electrolytic composition of the invention.

The anode sheet is prepared by applying a coating of a composition for electrodes which contains an anode active material onto a current collecting member, while the cathode sheet is prepared by applying a coating of a composition for electrodes which contains a cathode active material onto a current collecting member. In the following, a detailed explanation will be given on the materials for the anode sheet and the cathode sheet.

(A) Current collecting member

As the current collecting member for the anode sheet and the cathode sheet, usable is an electrically conductive material which does not cause a chemical change when constructed into a battery.

As the current collecting member for the anode sheet, preferably used is aluminum, stainless steel, nickel or titanium, as well as aluminum or stainless steel which is surface-treated with carbon, nickel or titanium or silver. Particularly preferred is aluminum or an aluminum alloy.

As the current collecting member for the cathode sheet, preferably used is copper, stainless steel, nickel or titanium. Particularly preferred is copper or a copper alloy.

The current collecting member is usually used in the shape of a film sheet. The current collecting member may also be used, for example, in the shape of a net, a punched member, a glass body, a porous body, a foamed body or a molded body of fibers. A thickness of the current collecting member is not particularly limited, but usually the thickness is 1 to 500 μm. It is also desirable to provide a rough surface on the current collecting member by carrying out surface-treatment.

(B) Composition for electrodes

The composition for electrodes (composition for an anode or composition for a cathode) used in the present invention includes, in addition to an anode active material (or a cathode active material) as the essential component, an electrically conductive agent, a binder, a filler and an aprotic organic solvent. The composition for electrodes is coated on the current collecting member, followed by drying and compressing. A detailed explanation of the components of the composition for electrodes will be given below.

(1) Anode Active Material

The composition for electrodes used for the anode sheet contains an anode active material as the essential component. As the anode active material, an oxide of a transition metal that is capable of reversibly adsorbing and desorbing lithium ions may be used. Particularly preferred is an oxide of a lithium-containing transition metal. Preferred examples of the oxide of the lithium-containing transition metal that constitutes the anode active material used in the invention include oxides of Ti, V, Cr, Mn, Fe, Co, Ni, Cu, Mo or W that contains lithium. The material may further include an alkali metal (an element of the group 1 (Ia) or 2 (IIa) of the periodic table) other than lithium, and/or Al, Ga, In, Ge, Sn, Pb, Sb, Bi, Si, P, B or the like. The amount of such an element to be included is preferably 0 to 30 mol % relative to the transition metal.

Synthesis of a more preferred oxide of a lithium-containing transition metal used for the anode active material is conducted by mixing a lithium compound and a transition metal compound (a transition metal as used in this case refers to at least one selected from Ti, V, Cr, Mn, Fe, Co, Ni, Mo and W) to make the sum of the compounds in a molar ratio from 0.3 to 2.2.

A more preferred oxide of a lithium-containing transition metal used for the anode active material may be synthesized by mixing a lithium compound and a transition metal compound (a transition metal as used in this case refers to at least one selected from V, Cr, Mn, Fe, Co and Ni) to make the sum of the compounds in a molar ratio from 0.3 to 2.2.

A particularly preferred oxide of a lithium-containing transition metal used for the anode active material is a material that includes Li_{g}M³O₂ (wherein M³ is at least one selected from Co, Ni, Fe and Mn; and g=0 to 1.2), or a material that has a spinel structure represented by LiₕM⁴₂O₄ (where in M⁴ is Mn; and h=0 to 2). The material may further include as M³ and M⁴, in addition to the transition metal, Al, Ga, In, Ge, Sn, Pb, Sb, Bi, Si, P, B or the like. The amount of such an element included is preferably 0 to 30 mol % relative to the transition metal.

The most preferred oxide of a lithium-containing transition metal used for the anode active material is Li_{g}CoO₂, Li_{g}NiO₂, Li_{g}MnO₂, Li_{g}CoⱼN₁₋ⱼO₂, or LiₕMn₂O₄ (wherein g=0.02 to 1.2; j=0.1 to 0.9; and h=0 to 2). The values g and h are those obtained before the charging or discharging operation is conducted, and the values may increase or decrease by effecting the charging or discharging operation.

The anode active material can be prepared by conventionally known methods, such as a method in which a lithium compound and a transition metal compound are mixed and sintered (a sintering method), or a method employing a reaction between the two compounds. The sintering method is particularly preferable.

An average particle size of the anode active material is not particularly limited. Preferably, the average particle size falls within a range of 0.1 to 50 μm. Also, a specific surface area thereof is not particularly limited. Preferably, the specific surface area falls within a range of 0.01 to 50 m²/g, as measured by a BET method. Incidentally, when 5 g of the anode active material is dissolved in 100 ml of distilled water, a supernatant of the resultant solution preferably has a pH value within a range of 7 to 12.

In order to achieve a prescribed particle size, the anode active material is pulverized using a grinding apparatus or a classifying apparatus which is well known in the art, such as a mortar, a ball mill, a vibrating ball mill, a vibration mill, a satellite ball mill, a planetary ball mill, a swing-air-flow jet mill or a sieve.

The anode active material obtained by the sintering method may be used after it is rinsed with water, an acidic aqueous solution, an alkaline aqueous solution or an organic solvent.

(2) Cathode Active Material

The composition for electrodes used for the cathode sheet contains a cathode active material as an essential component. Examples of the cathode active material employable in the secondary battery of the invention include (i) a carbon material capable of reversibly absorbing and desorbing lithium, or (ii) an oxide and/or a chalcogenide.

(i) Carbon material

A carbon material as used herein refers to a material substantially made of carbon. Examples thereof include petroleum pitch, natural graphite, artificial graphite such as vapor-phase epitaxy graphite, and carbon materials obtained by sintering various synthetic resins such as PAN-type resin and furfuryl alcohol resin. Further, various carbon fibers such as PAN-type carbon fibers, cellulose-type carbon fibers, pitch-type carbon fibers, vapor-phase epitaxy carbon fibers, dehydrated PVA-type carbon fibers, lignin-type carbon fibers, glass-like carbon fibers or active carbon-based carbon fibers, mesophase microspheres, graphite whisker or plate-shape graphite may be used as the carbon material.

These carbon materials can be divided into a slightly graphitizable carbon material and a graphite-type carbon material, according to a level of graphitization. It is preferable that the carbon material has a plane pitch, a density and a crystal latice size as described in JP-A Nos. 62-22066, 2-6856 and 3-45473.

The carbon material need not be made of a single material. A mixture of natural graphite and artificial graphite as described in JP-A No. 5-90844, or graphite having a covering layer as described in JP-A No. 6-4516 may be used.

(ii) Oxide, and Chalcogenide

As the cathode active material used in the secondary battery of the invention, an oxide and/or a chalcogenide may be employed. An amorphous oxide and/or a chalcogenide is particularly preferred. An amorphous material as used herein refers to a material which shows a broad scattering band having a peak within a range of 20 to 40° at 2θ value in an X-ray diffraction by irradiating CuKα ray and which may also have a crystalline diffraction line. Preferable amorphous materials have the highest intensity of crystalline diffraction lines within a range from 40° to 70° at 2θ value of 100 times or less, as compared with the diffraction intensity of the peak of the broad scattering band observed within a range from 20° to 40° at 2θ value, and more preferably 5 times or less, and particularly preferably having no crystalline scattering lines.

For use in the present invention, particularly preferred is an amorphous oxide of a semi-metal element and/or a chalcogenide, and preferably selected is an oxide of elements of groups 13(IIIb) to 15(Vb) of the periodic table, namely, Al, Ga, Si, Sn, Ge, Pb, Sb and Bi, singly or in combination of two or more kinds thereof and/or a chalcogenide.

Preferred examples include Ga₂O₃, SiO, GeO, SnO, SnO₂, PbO, PbO₂, Pb₂O₃, Pb₂O₄, Pb₃O₄, Sb₂O₃, Sb₂O₄, Sb₂O₅, Bi₂O₃, Bi₂O₄, SnSiO₃, GeS, SnS, SnS₂, PbS, PbS₂, Sb₂S₃, Sb₂S₅, and SnSiS₃. These may be a composite oxide with lithium oxide, such as Li₂SnO₂.

As the cathode active material used in the invention, preferred is an amorphous oxide principally made of Sn, Si or Ge, among which particularly preferred is an amorphous oxide represented by the general formula (6):

SnM¹_{d}M²ₑO_{f} (6)

wherein M¹ represents at least one element selected from Al, B, P, Si and Ge; M² represents at least one element selected from the elements of the group 1(Ia), the elements of the group 2(IIa) and the elements of the group 3(IIIa) of the periodic table and halogen atoms; d represents a value of from 0.2 to 2, e represents a value of from 0.01 to 1 and satisfying the requirement of 0.2<d+f<2; and f represents a value of from 1 to 6.

Examples of the amorphous oxide principally made of Sn include those listed below, but the present invention is not limited thereto:

C-1 SnSiO₃

C-2 SnAl_{0.2}B_{0.4}P_{0.2}Si_{0.6}O_{3.6}

C-3 SnAl_{0.4}B_{0.6}Cs_{0.1}P_{0.5}O_{3.65}

C-4 SnAl_{0.4}B_{0.5}Mg_{0.1}P_{0.5}O_{3.7}

C-5 SnAl_{0.4}B_{0.4}Ba0.08P_{0.4}O_{3.28}

C-6 SnAl_{0.4}B_{0.5}Ba_{0.08}Mg_{0.08}P_{0.3}O_{3.26}

C-7 SnAl_{0.1}B_{0.2}Ca_{0.1}P_{0.1}Si_{0.5}O_{3.1}

C-8 SnAl_{0.2}B_{0.4}Si_{0.4}O_{2.7}

C-9 SnAl_{0.2}B_{0.1}Mg_{0.1}P_{0.1}Si_{0.5}O_{2.6}

C-10 SnAl_{0.3}B_{0.4}P_{0.2}Si_{0.5}O_{3.55}

C-11 SnAl_{0.3}B_{0.4}P_{0.5}Si_{0.5}O_{4.3}

C-12 SnAl_{0.1}B_{0.1}P_{0.3}Si_{0.6}O_{3.25}

C-13 SnAl_{0.1}B_{0.1}Ba_{0.2}P_{0.1}Si_{0.6}O_{2.95}

C-14 SnAl_{0.1}B_{0.1}Ca_{0.2}P_{0.1}Si_{0.6}O_{2.95}

C-15 SnAl_{0.4}B_{0.2}Mg_{0.1}Si_{0.6}O_{3.2}

C-16 SnAl_{0.1}B_{0.3}P_{0.1}Si_{0.5}O_{3.05}

C-17 SnB_{0.1}K_{0.5}P_{0.1}SiO_{3.65}

C-18 SnB_{0.5}F_{0.1}Mg_{0.1}P_{0.5}SiO_{3.05}

The amorphous oxide and/or chalcogenide to be used in the invention can be prepared by a sintering method or a solution method, with the sintering method being the more preferred. When the sintering method is employed, it is preferable to mix the oxides, chalcogenides or the compounds of corresponding elements thoroughly and sintering the resulting mixture to obtain the amorphous oxide and/or chalcogenide. These can be prepared employing a conventionally known method.

The cathode active material used in the invention preferably has an average particle size of 0.1 to 60 μm. In order to obtain a predetermined particle size, a grinding apparatus or a classifying apparatus that is well known in the art, such as a mortar, a ball mill, a sand mill, a vibrating ball mill, a satellite ball mill, a planetary ball mill, a swing-air-flow jet mill or a sieve may be used. When the grinding operation is conducted, wet grinding in the presence of water or an organic solvent such as methanol may be carried out as necessary. In order to achieve a predetermined particle size, the ground particles are preferably subjected to classification. The classifying method is not particularly limited and, for example, a sieve or an air classifier may be used as necessary. The classification may be performed either in a dry method or in a wet method.

Additional cathode materials used in the invention, in combination with the amorphous oxide cathode material that is principally made of Sn, Si or Ge, may be a carbon material capable of absorbing and desorbing lithium ions or lithium metal, lithium, a lithium alloy or a metal capable of forming an alloy with lithium.

(3) Electrically Conductive Agent

The electrically conductive agent used for the composition for electrodes may be any electrically conductive material insofar as it does not cause a chemical change in the battery constructed. Usually, an electrically conductive material such as natural graphite (flake graphite, scale graphite, muddy graphite or the like), artificial graphite, carbon black, acetylene black, ketchen black, carbon fibers, a metal powder (copper, nickel, aluminum, silver (JP-A No. 63-148554) or the like), metal fibers or a polyphenylene derivative (JP-A No. 59-20971) may be included singly or as a mixture thereof. Particularly preferred is a combination of graphite and acetylene black. The addition amount thereof is preferably from 1 to 50% by mass, particularly preferably from 2 to 30% by mass. In case using carbon or graphite, particularly preferred addition amount is from 2 to 15% by mass.

(4) Binder

In the present invention, a binder is used for maintaining the composition for electrodes. Examples of the binder include a polysaccharide, a thermoplastic resin and a polymer exhibiting rubber elasticity. Preferred examples of the binder include an emulsion (latex) or a suspension of starch, carboxymethyl cellulose, cellulose, diacetyl cellulose, methyl cellulose, hydroxyethyl cellulose, hydroxypropyl cellulose, sodium alginate, polyacrylic acid, sodium polyactylate, polyvinylphenol, polyvinyl methyl ether, polyvinyl alcohol, polyvinylpyrrolidone, polyacrylonitrile, polyacrylamide, polyhydroxy (meth)acrylate, a styrene/maleic acid copolymer or the like water-soluble polymer, polyvinyl chloride, polytetrafluoroethylene, polyvinylidene fluoride, a tetrafluoroethylene/hexafluoropropylene copolymer, a vinylidene fluoride/tetrafluoroethylene/hexafluoropropylene copolymer, polyethylene, polypropylene, an ethylene/propylene/diene terpolymer (EPDM), a sulfonated EPDM, polyvinylacetal resin, a (meth)acrylic acid ester copolymer containing a (meth)acrylic acid ester such as methyl methacrylate or 2-ethylhexyl acrylate, a (meth)acrylic acid ester/acrylonitrile copolymer, a polyvinyl ester copolymer containing a vinyl ester such as vinyl acetate, a styrene/butadiene copolymer, an acrylonitrile/butadiene copolymer, polybutadiene, Neoprene rubber, fluorinated rubber, polyethylene oxide, polyester polyurethane resin, polyether polyurethane resin, polycarbonate polyurethane resin, polyester resin, phenolic resin, or epoxy resin. Particularly preferred are a polyacrylic acid ester latex, carboxymethyl cellulose, polytetrafluoroethylene and polyvinylidene fluoride.

These binders may be used singly or in admixture thereof. A too small addition amount of the binder results in a weak maintaining or coagulating force of the composition for electrodes. A too large addition amount of the binder increases the volume of the electrode, to thereby decrease the capacity per unit volume or unit mass of the electrode. For these reasons, the addition amount of the binder is preferably from 1 to 30% by mass, particularly preferably from 2 to 10% by mass.

(5) Filler As the filler, any fibrous material may be used insofar as it does not cause a chemical change in the battery constructed. Usually, the fibers of an olefinic polymer such as polypropylene or polyethylene, glass or carbon may be used. The addition amount of the filler is not particularly limited, but preferably the filler is added in a range from 0 to 30% by mass.

(C) Method of preparing anode/cathode sheet

An anode sheet or a cathode sheet can be prepared by applying a coating of the above-described composition for electrodes onto the current collecting member, followed by drying and compressing.

Applying a coating may be carried out, for example, by a reverse roll coating, a direct roll coating, a blade coating, a knife coating, an extrusion coating, a curtain coating, a gravure coating, a bar coating, a dip coating or a squeeze coating. Among these, preferable is a blade coating, a knife coating or an extrusion coating. Applying of a coating is preferably conducted at a speed of 0.1 to 100 m/min. When such a coating is carried out, a satisfactory surface state can be obtained in the coating layer by selecting the aforementioned coating method depending on the physical properties and drying properties of a coating solution of the composition for electrodes. Coating may be performed in a successive manner at one surface, or simultaneously at both surfaces.

Also, the coating may be carried out continuously or in an intermittent manner or in a striped form. A thickness, a length and a width of the coating layer are determined according to a shape and a size of the battery, but the thickness of the coating layer on one surface is preferably within a range of 1 to 2000 μm in a compressed state after drying.

The coated electrode sheet can be dried and dehydrated using a hot air, vacuum, an infrared ray, a far infrared ray, an electron beam or a low humidity air, singly or in combination thereof. The coated electrode sheet is preferably dried at a temperature from 80 to 350° C., and particularly preferably from 100 to 250° C. A water content is preferably 2000 ppm or less in the entire battery, with each of the composition for anodes, the composition for cathodes and the electrolyte being preferably 500 ppm or less. The coated sheet can be pressed through an ordinary method, preferably using a calender pressing method. A pressing pressure is not particularly limited, but is preferably within a range of 0.2 to 3 t/cm². The calender pressing method is preferably employed at a pressing speed of 0.1 to 50 m/min and at a pressing temperature from room temperature to 200° C. A ratio of a width of the cathode sheet to that of the anode sheet is preferably from 0.9 to 1.1, and particularly preferably from 0.95 to 1.0. A ratio of the contents of the anode active material and the cathode active material varies depending on the species of the compounds used and the composition of the composition for electrodes.

(D) Method of assembling secondary battery

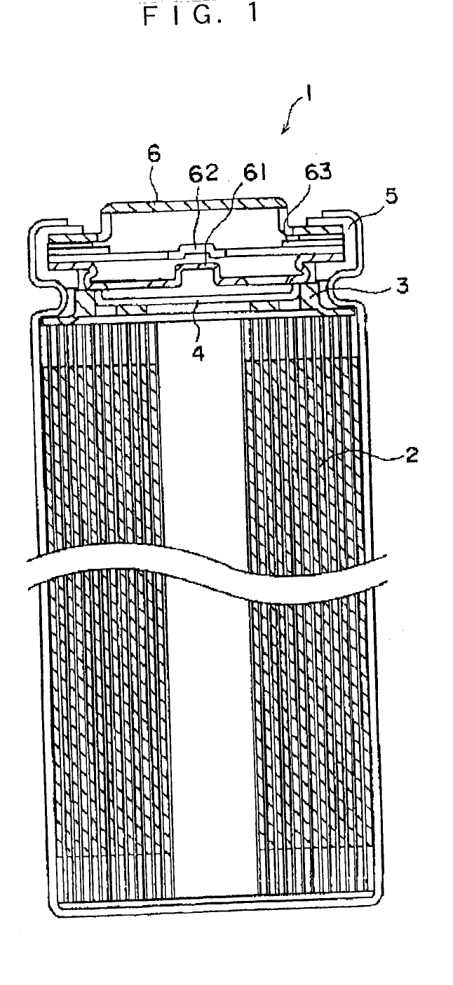

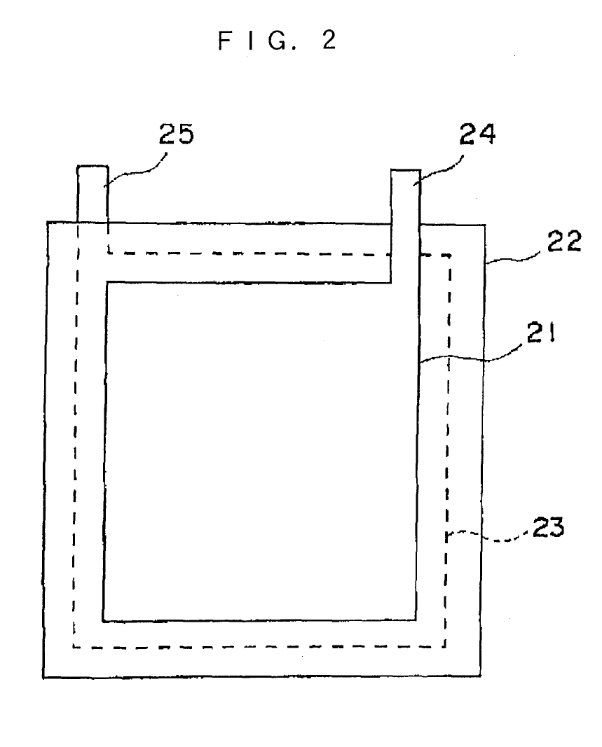

The secondary battery of the present invention is produced by layering the anode sheet and the cathode sheet with a gap therebetween and filling the gap with the electrolytic composition of the invention. Preferably, a cylinder-shaped battery is produced as shown in FIG. 1 and a sheet-shaped battery is produced as shown in FIG. 2. In the cylinder-shaped battery as shown in FIG. 1, the electrolytic composition of the invention is poured to an electrode group 2 which is formed by winding the anode sheet and the cathode sheet, with a non-woven cloth or a separator sandwiched therebetween. In the sheet-shaped battery as shown in FIG. 2, the anode sheet 21 and the cathode sheet 23 are layered with a non-woven cloth 22 sandwiched therebetween, and the electrolytic composition of the invention is poured to the non-woven cloth 22 under reduced pressure. In FIG. 2, an anode terminal 24 and a cathode terminal 25 are shown.

As the separator, an insulating thin film exhibiting a large ionic permeability and a predetermined mechanical strength is used. In order to secure safety, the separator is required to have a function of interrupting electric currents by blocking pores at 80° C. or higher to raise the resistance, and the temperature of blocking pores employed is preferably from 90° C. to 180° C.

The separator has pores normally having a circular or oval shape, and a size of 0.05 to 30 μm, preferably 0.1 to 20 μm. Alternatively, the pore may have a rod or unfixed shape as in a case where the separator is prepared through an extension method or a phase separation method. A proportion of such pores occupying the separator, namely a pore proportion, is from 20 to 90%, and preferably from 35 to 80%.

The separator may be made of a single material such as polyethylene or polypropylene, or a composite material composed of two or more substances. Particularly preferred is a laminate of fine-porous films of two or more kinds, which are mutually different in the pore size, the pore proportion, the temperature of blocking pores and the like.

The anode sheet and the cathode sheet layered with the separator therebetween may be worked into a sheet-shaped battery, or folded, then inserted into a rectangular canister to form a rectangular battery by electrically connecting the canister with the sheet, charging the electrolytic composition of the invention and closing the canister with a sealing plate. Also, the anode sheet and the cathode sheet layered with the separator therebetween may be wound and inserted into a cylindrical canister, followed by electrically connecting the canister with the sheet, charging the electrolytic composition of the invention and closing the canister with a sealing plate to thereby produce a cylinder-shaped battery. In this process, a safety valve may be used as the sealing plate. Besides the safety valve, other known protective elements may be equipped. For example, there may be employed a fuse, a bimetal, or a PTC element as an overcurrent preventing element.

Further, in order to cope with an internal pressure increase in the battery canister, besides the safety valve, a method of providing the battery canister having a notch, a method forming a crack in a gasket or in the sealing plate, or a method of forming a cut in a leading plate may be employed. Also, a protective circuit in which a measure to cope with an overcharging or an overdischarging is incorporated may be provided in a charger or may be independently connected.

Furthermore, in order to cope with the overcharging, a method of interrupting the current by increasing the internal pressure of the battery is employed. In such a method, a compound for elevating the internal pressure may be included in the composition for electrodes or the electrolyte. Examples of the compound used for elevating the internal pressure include carbonate salts such as Li₂CO₃, LiHCO₃, Na₂CO₃, NaHCO₃, CaCO₃ and MgCO₃.

The canister or the lead plate may be made of a metal or an alloy exhibiting electrical conductivity. For example, a metal such as iron, nickel, titanium, chromium, molybdenum, copper, aluminum or the alloy thereof may be used.

In order to weld the cap, the canister, the sheet and the lead plate, a well known method (e.g., DC or AC electrical welding, laser welding or ultrasonic welding) may be employed. As the sealing material for the aperture, a conventionally known compound or mixture, such as asphalt may be used.

(E) Specific examples of internal structure of secondary battery

In a preferred embodiment, the secondary battery of the invention may be produced, as shown in FIG. 1, by inserting a wound electrode group 2, comprising an anode sheet and a cathode sheet wound together with a non-woven cloth or a separator, into a battery canister 1, electrically connecting the battery canister 1 with the cathode sheet, charging the electrolytic composition of the invention and sealing the aperture of the canister. A battery cover 6 also serves as an anode terminal and is fitted with an upper aperture of the battery canister 1 across a gasket 5. The anode sheet is electrically connected to the battery cover 6 via an anode lead 4.

A sealing body comprising, successively from the uppermost, the battery cover 6, a ring-shaped PTC element 63, a current interrupting element 62 and a pressure-sensitive valve body 61, is fitted with and supported by a gasket 5. The battery cover 6 constitutes a surfacially exposed portion of the battery, and the pressure-sensitive valve body 61 is positioned inside. An insulating cover 61a covers a surface of an upper portion of the pressure-sensitive valve body 61.

The wound electrode group 2 is obtained, for example, by layering the anode sheet, the separator, the cathode sheet and the separator in this order, and winding the resultant layered product. An upper insulating plate 3 is provided between the wound electrode group 2 and the pressure-sensitive valve body 61. The upper insulating plate 3 insulates the electrode group 2 from the aperture sealing body, and further insulates the electrode group 2 from the battery canister 1. Also a lower insulating plate 7 is provided between the electrode group and the battery canister 1 to thereby insulate the electrode group from the battery canister 1.

The PTC element 63 has a function of interrupting electric currents by elevating the temperature within the battery and inducing an increase in the resistance. The current interrupting element 62 is a laminate of a first conductive body 62a, an insulating ring 62c and a second conductive body 62b, in which the first conductive body 62a is provided at a side of the pressure-sensitive valve body 61 and has a through hole, while the second conductive body 62b is provided at a side of the PTC element 63, namely at a side of the battery cover 6, and has a through hole. The first conductive body 62a is electrically connected with the second conductive body 62b at a central part, and the first conductive body 62a has a thinner part around such a connecting part. The pressure-sensitive valve body 61 is a member capable of deforming to a side opposite to the electrode group in response to an increase in the internal pressure and capable of lifting the central connecting part of the above-mentioned first conductive body 62a. When the internal pressure of the battery is elevated by an abnormal reaction taken place therein, the pressure-sensitive valve body 61 undergoes deformation to break the connecting part of the first conductive body 62a and the second conductive body 62b in the current interrupting element 62, to thereby interrupt the electrical currents. In case where a further increase in the pressure occurs, the thinner part of the pressure-sensitive valve body 61 is broken to release the pressure. Since the current interrupting element 62 is provided at an opposite side to the electrode group with respect to the pressure-sensitive valve body 61, an explosion of the battery due to an inflammation of evaporated electrolyte can be prevented even if a spark occurs at an interrupting portion.

FIG. 1 illustrates a cylinder-shaped battery, but this battery is applicable to a cylinder or rectangle-shaped battery. The cylinder-shaped battery may be produced using a cylindrical winding core, and the rectangle-shaped battery may be produced using a rectangular winding core.

The application of the non-aqueous electrolytic secondary battery of the present invention is not particularly limited. The non-aqueous electrolytic secondary battery may be used in electronics, for example, a notebook personal computer, a pen-input personal computer, a mobile personal computer, an electronic book player, a mobile telephone, a cordless slave telephone, a pager, a handy terminal, a portable facsimile, a portable copier, a portable printer, a head phone stereo player, a portable video camera, a liquid crystal television, a handy cleaner, a portable CD, a minidisk player, an electric shaver, a transceiver, an electronic notebook, an electronic calculator, a memory card, a portable tape recorder, a radio, a backup power supply, and a memory card. The non-aqueous electrolytic secondary battery of the invention is also usable in other consumer applications, for example, an automobile, an electrically powered vehicle, a motor, an illuminating equipment, a toy, a gaming machine, a load conditioner, a watch, a strobe flash light, a camera or a medical equipment (pacemaker, hearing aid, massager etc.). The non-aqueous electrolytic secondary battery is further usable in a military application or a space application, and may be used in combination with a solar cell.

### EXAMPLES

The present invention will now be fully described with reference to the following examples, but it is to be understood that the invention is not limited to the examples.

### Example 1

(1) Preparation of Electrolytic Composition

A mixture of a silicon polymer (A-1, 10 g) of the present invention and N-lithium-bis-(trifluoromethane)sulfonimide (4 g) was dissolved in acetonitrile (5 ml), to which was added 1 g of silica (trade name AEROSIL50, manufactured by Nippon Aerosil Co.). Then, acetonitrile was distilled off under reduced pressure to thereby obtain an electrolytic composition (E-1).

Electrolytic compositions (E-2) to (E-18) having respective compositions shown in Tables 1 and 2 were prepared in a similar manner as above, except that the kinds of the silicon polymers of the invention, the inorganic fine particles, the metal ion salts and the fused salts used were changed.

(2) Preparation of Solid Electrolyte

10 g of the electrolytic composition (E-1) prepared in (1) above was mixed with 0.5 g of an exemplified compound d as the nucleophilic agent. The obtained liquid was cast on Teflon (trade name). The thus cast liquid was heated at 100° C. for 4 hours in an argon gas atmosphere to obtain a solid electrolyte thin film (SPE-1).

Solid electrolyte thin films (SPE-2) to (SPE-13) having respective compositions shown in Table 3 were obtained in a similar manner as above, except that the kinds of the electrolytic compositions and the nucleophilic agents used were changed.

(3) Measurement of Ionic Conductivity and Ion Transport Number

Each of the electrolytes prepared in (1) and (2) was sandwiched between two lithium electrodes which were separated by a polypropylene spacer having a thickness of 0.5 mm. Then, ionic conductivity and Li ion transport number were measured through a composite impedance measuring method in combination with a DC polarization method. The obtained results are shown in Tables 1 to 3 below.

TABLE 1

| | | | | Fused | | | |
|---|---|---|---|---|---|---|---|
| | | | | Salt | Ionic | | |
| | | | | (% by | Conduc- | | |
| | | | | mass to | tivity | Li Ion | |
| | Silicon | Inorganic | Metal | Silicon | × 10⁻⁴ | Transport | |
| No. | Polymer | Fine Particles | Ion Salt | Polymer) | (S/cm) | Number | Remarks |
| E-1 | A-1 | Silica | LiNTf₂ | — | 1.1 | 0.8 | Present |
| | | (AEROSIL50, | | | | | Invention |
| | | Nippon | | | | | |
| | | Aerosil Co.) | | | | | |
| E-2 | A-2 | Silica | LiNTf₂ | — | 1.0 | 0.7 | Present |
| | | (AEROSIL50, | | | | | Invention |
| | | Nippon | | | | | |
| | | Aerosil Co.) | | | | | |
| E-3 | A-4 | Silica | LiNTf₂ | — | 1.6 | 0.9 | Present |
| | | (AEROSIL50, | | | | | Invention |
| | | Nippon | | | | | |
| | | Aerosil Co.) | | | | | |
| E-4 | A-10 | Silica | LiNTf₂ | — | 0.8 | 0.8 | Present |
| | | (AEROSIL50, | | | | | Invention |
| | | Nippon | | | | | |
| | | Aerosil Co.) | | | | | |
| E-5 | A-14 | Silica | LiNTf₂ | — | 1.4 | 0.7 | Present |
| | | (AEROSIL50, | | | | | Invention |
| | | Nippon | | | | | |
| | | Aerosil Co.) | | | | | |
| E-6 | A-7 | Silica | LiNTf₂ | — | 0.8 | 0.7 | |
| | | (AEROSIL50, | | | | | |
| | | Nippon | | | | | |
| | | Aerosil Co.) | | | | | |
| E-7 | A-19 | Silica | LiNTf₂ | — | 0.8 | 0.7 | |
| | | (AEROSIL50, | | | | | |
| | | Nippon | | | | | |
| | | Aerosil Co.) | | | | | |
| E-8 | A-22 | Silica | LiNTf₂ | — | 0.7 | 0.7 | |
| | | (AEROSIL50, | | | | | |
| | | Nippon | | | | | |
| | | Aerosil Co.) | | | | | |

TABLE 2

| | | | | | | | |
|---|---|---|---|---|---|---|---|
| E-9 | A-20 | Silica | LiNTf₂ | — | 1.4 | 0.7 | Present |
| | | (AEROSIL50, | | | | | Invention |
| | | Nippon | | | | | |
| | | Aerosil Co.) | | | | | |
| E-10 | A-1 | Silica | LiPF₆ | — | 1.0 | 0.7 | Present |
| | | (AEROSIL50, | | | | | Invention |
| | | Nippon | | | | | |
| | | Aerosil Co.) | | | | | |
| E-11 | A-4 | Silica | LiNTf₂ | — | 1.5 | 0.8 | Present |
| | | (AEROSIL972, | | | | | Invention |
| | | Nippon | | | | | |
| | | Aerosil Co.) | | | | | |
| E-12 | A-4 | Silica | LiNTf₂ | — | 1.4 | 0.8 | Present |
| | | (AEROSIL | | | | | Invention |
| | | R812, | | | | | |
| | | Nippon | | | | | |
| | | Aerosil Co.) | | | | | |
| E-13 | A-4 | Silica | LiNTf₂ | Compound A | 3.2 | 0.7 | Present |
| | | (AEROSIL50, | | (20) | | | Invention |
| | | Nippon | | | | | |
| | | Aerosil Co.) | | | | | |
| E-14 | A-4 | Aluminum | LiNTf₂ | — | 1.4 | 0.7 | Present |
| | | Oxide C | | | | | Invention |
| | | (Nippon | | | | | |
| | | Aerosil Co.) | | | | | |
| E-15 | A-4 | Titanium | LiNTf₂ | — | 1.4 | 0.7 | Present |
| | | Dioxide P25 | | | | | Invention |
| | | (Nippon | | | | | |
| | | Aerosil Co.) | | | | | |
| E-16 | A-4 | — | LiNTf₂ | — | 0.3 | 0.7 | Comp. |
| | | | | | | | Example |
| E-17 | A-4 | — | | Compound A | 0.7 | 0.5 | Comp. |
| | | | | (20) | | | Example |
| E-18 | PEG600 | Aluminum | | | 0.1 | 0.3 | Comp. |
| | | Oxide C | | | | | Example |
| | | (Nippon | | | | | |
| | | Aerosil Co.) | | | | | |

NTf₂: (N(SO₂CF₃)₂)
PEG600: polyethylene glycol; average molecular weight 600

TABLE 3

| | | Nucleophilic | | | |
|---|---|---|---|---|---|
| | Electrolytic | Agent | Ionic | Li Ion | |
| Sample | composition | (amount | Conductivity | Transport | |
| No. | (amount used) | used) | × 10⁻⁵ (S/cm) | Number | Remarks |
| SPE-1 | E-1 (10 g) | d (0.5 g) | 0.9 | 0.7 | Present |
| | | | | | Invention |
| SPE-2 | E-3 (10 g) | d (1.0 g) | 1.3 | 0.8 | Present |
| | | | | | Invention |
| SPE-3 | E-3 (10 g) | e (2.0 g) | 1.2 | 0.7 | Present |
| | | | | | Invention |
| SPE-4 | E-3 (10 g) | f (3.0 g) | 1.1 | 0.7 | Present |
| | | | | | Invention |
| SPE-5 | E-3 (10 g) | j (1.0 g) | 1.2 | 0.8 | Present |
| | | | | | Invention |
| SPE-6 | E-3 (10 g) | m (1.0 g) | 1.2 | 0.7 | Present |
| | | | | | Invention |
| SPE-7 | E-5 (10 g) | e (1.0 g) | 1.1 | 0.6 | Present |
| | | | | | Invention |
| SPE-8 | E-9 (10 g) | e (1.0 g) | 1.1 | 0.6 | Present |
| | | | | | Invention |
| SPE-9 | E-13 (10 g) | e (1.0 g) | 1.1 | 0.6 | Present |
| | | | | | Invention |
| SPE-10 | E-14 (10 g) | e (1.0 g) | 1.1 | 0.6 | Present |
| | | | | | invention |
| SPE-11 | E-7 (10 g) | e (1.0 g) | 0.7 | 0.6 | |
| SPE-12 | E-16 (10 g) | e (1.0 g) | 0.6 | 0.5 | Comp. |
| | | | | | Example |
| SPE-13 | PEO(10 g)/ | — | 0.2 | 0.3 | Com. |
| | Silica(1 g) | | | | Example |
| | (AEROSIL50) | | | | |
| | Nippon | | | | |
| | Aerosil Co.)/ | | | | |
| | LiNTf₂ (4 g) | | | | |

PEO: polyethylene oxide; average molecular weight 300,000

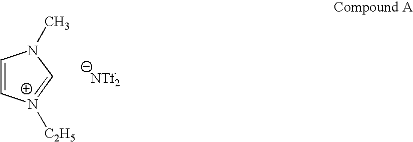

As seen from the results shown in Tables 1 to 3, the electrolytes prepared using the specified compounds of the invention showed ionic conductivity at least equal to those obtained in Comparative Examples and Li ion transport numbers greater than those obtained therein, and hence are revealed to be useful as the lithium ion conductive material.

(4) Production of Secondary Battery <1>

(Preparation of paste of composition for anode)

As the anode active material, 200 parts by weight of LiCoO₂ and 10 g of acetylene black were mixed using a homogenizer, to which were added as the binder 8 g of an aqueous dispersion (solid concentration 50 wt %) of a 2-ethylhexyl acrylate/acrylic acid/acrylonitrile copolymer and 60 g of a 2 wt % aqueous solution of carboxymethyl cellulose and then kneaded. To the kneaded product was added 50 g of water, and stirring was provided using a homogenizer to thus prepare a paste of the composition for anodes.

(Preparation of paste of composition for cathode)

As the cathode active material, 200 g of SnGe_{0.1}B_{0.5}P_{0.58}K_{0.1}O_{3.35} and 30 g of an electrically conductive material (artificial graphite) were mixed using a homogenizer, to which were added as the binder 50 g of a 2 wt % aqueous solution of carboxymethyl cellulose and 10 g of polyfluorovinylidene and then kneaded. To the resultant mixture was further added 30 g of water and kneaded to prepare a paste of the composition for cathodes.

(Preparation of anode sheet and cathode sheet)

The paste of the composition for anodes prepared as above was coated using a blade coater on both surfaces of an aluminum foil that constituted the current collecting member having a thickness of 30 μm, to provide a coating amount of 400 g/m² and a sheet thickness of 280 μm after compressed, then dried, press molded by a roller press and cut into a predetermined size to obtain a stripe-shaped anode sheet. The resultant sheet was sufficiently dried and dehydrated using a far infrared heater in a dry box (containing dry air having a dew point of −50° C. or lower) to prepare an anode sheet.

In a similar manner to the above, the paste of the composition for cathodes was coated on a copper foil that constituted the current collecting member having a thickness of 20 μm to prepare a cathode sheet with a coating amount of 70 g/m² and a sheet thickness of 90 μm after compressed.

(Production of cylinder-shaped battery)

Next, a process of producing the battery will be described with reference to FIG. 1. The anode sheet prepared above, a non-woven cloth TAPYRUS P22FW—OCS having a thickness of 30 μm (manufactured by Tonen Tapyrus Co., Ltd.), the cathode sheet and a non-woven cloth TAPYRUS P22FW—OCS having a thickness of 30 μm (manufactured by Tonen Tapyrus Co., Ltd.) were layered successively and wound into a spiral form. The spirally wound electrode group (2) was introduced into an iron cylindrical battery canister (1) having a bottom and serving as a cathode terminal on which nickel was plated, and the aforementioned electrolyte E-I was poured thereinto at 70° C. under reduced pressure. Further, an upper insulating plate (3) was inserted thereinto. A layered product made of the anode terminal (6), an insulating ring, the PTC element (63), the current interrupting body (62) and the pressure-sensitive valve body (61) was caulked across a gasket (5) to produce a cylinder-shaped battery (Example 1). Similarly, the batteries of Examples 2 to 9 and Comparative Examples 1 and 2 were produced, each in the number of ten, using the electrolytes shown in Table 4 below.

(5) Production of secondary battery <2>

The cylinder-shaped batteries (Examples 10 to 18, Comparative Example 3) were produced in a similar manner to (4) above, except that a graphite powder was used as the cathode material.

(Evaluation of Battery performance)

Each of the batteries produced through the process in (4) or (5) was subjected to 10 cycles of charging and discharging under conditions of 0.2 C, a charging end voltage of 4.1 V and a discharging end voltage of 2.7 V, and measured for a discharging capacity at the tenth cycle. The capacities obtained in ten batteries having the same formulation were averaged to define the capacity of such batteries. The capacity of each of the batteries thus determined was divided by the capacity of the battery of Example 1 to obtain a relative capacity. Also in each of the batteries, the discharging capacity at the 100th cycle at 0.5 C (charging end voltage 4.1 V, discharging end voltage 2.7 V) was measured, and a cycle capacity was determined by calculating a ratio of the above capacity to the discharging capacity at the 10th cycle. The results are shown in Table 4.

TABLE 4

| Battery No. | Electrolyte | Relative Capacity | Cycle Capacity |
|---|---|---|---|
| Example 1 | E-1 | 1 | 0.94 |
| Example 2 | E-3 | 1.20 | 0.91 |
| Example 3 | E-5 | 1.11 | 0.92 |
| Example 4 | E-9 | 1.11 | 0.92 |
| Example 5 | E-11 | 1.15 | 0.91 |
| Example 6 | E-13 | 2.90 | 0.92 |
| Example 7 | E-14 | 1.12 | 0.91 |
| Example 8 | E-6 | 0.97 | 0.91 |
| Example 9 | E-8 | 0.96 | 0.91 |
| Comp. Ex. 1 | E-16 | 0.77 | 0.91 |
| Comp. Ex. 2 | E-18 | 0.56 | 0.90 |
| Example 10 | E-1 | 0.94 | 0.91 |
| Example 11 | E-3 | 1.05 | 0.89 |
| Example 12 | E-5 | 1.01 | 0.88 |
| Example 13 | E-9 | 1.02 | 0.89 |
| Example 14 | E-11 | 1.05 | 0.89 |
| Example 15 | E-13 | 2.46 | 0.89 |
| Example 16 | E-14 | 0.99 | 0.90 |
| Example 17 | E-6 | 0.91 | 0.90 |
| Example 18 | E-8 | 0.89 | 0.89 |
| Comp. Ex. 3 | E-16 | 0.65 | 0.86 |

These results indicate that the electrolytes prepared using the specified compounds of the present invention improved the cycle characteristics without deteriorating the capacity. It is also revealed that an effect of stabilizing cycle characteristics increased when an amorphous composite oxide was used in the cathode, as compared to the carbon material used. On the other hand, when the conventional electrolytic compositions were used, the capacity was lowered and the cycle characteristics were barely equal or lower.

Similar results were obtained when LiNiO₂ or LiMnO₂ was used as the anode active material.

(6) Production of Secondary Battery <3>

(Preparation of anode sheet <1>)

As the anode active material, 43 parts by weight of LiCoO₂, 2 parts by weight of flake graphite, 2 parts by weight of acetylene black, 3 parts by weight of polyacrylonitrile as the binder and 100 parts by weight of acrylonitrile as the solvent were mixed and kneaded to obtain a slurry. The obtained slurry was coated on an aluminum foil having a thickness of 20 μm using an extrusion coater, then dried and press molded by a calender press. Then an aluminum leading plate was welded at an end of the molded product to obtain an anode sheet (CA-1) having a thickness of 95 μm, a width of 54 mm and a length of 49 mm.

(Preparation of anode sheet <2>)

As the anode active material, 43 parts by weight of LiMn₂O₄, 2 parts by weight of flake graphite, 2 parts by weight of acetylene black, 3 parts by weight of polyacrylonitrile as the binder and 100 parts by weight of acrylonitrile as the solvent were mixed and kneaded to obtain a slurry. The obtained slurry was coated on an aluminum foil having a thickness of 20 μm using an extrusion coater, then dried and press molded using a calender press. Then an aluminum leading plate was welded at an end of the molded product to obtain an anode sheet (CA-2) having a thickness of 114 μm, a width of 54 mm and a length of 49 mm.

(Preparation of anode sheet <3>)

As the anode active material, 43 parts by weight of LiNiO₂, 2 parts by weight of flake graphite, 2 parts by weight of acetylene black, 3 parts by weight of polyacrylonitrile as the binder and 100 parts by weight of acrylonitrile as the solvent were mixed and kneaded to obtain a slurry. The obtained slurry was coated on an aluminum foil having a thickness of 20 μm using an extrusion coater, then dried and press molded using a calender press. Then an aluminum leading plate was welded at an end of the molded product to obtain an anode sheet (CA-3) having a thickness of 75 μm, a width of 54 mm and a length of 49 mm.

(Preparation of cathode sheet <1>)

43 parts by weight of SnSiO₄ as the cathode active material were mixed with 2 parts by weight of acetylene black and 2 parts by weight of graphite as the electrically conductive material, to which were added 3 parts by weight of polyacrylonitrile as the binder and 100 parts by weight of N-methylpyrrolidone as the solvent, and the resultant mixture was kneaded to obtain a slurry used for the composition for cathodes.

Then, 45 parts by weight of α-alumina, 7 parts by weight of graphite, 3 parts by weight of polyacrylonitrile and 100 parts by weight of N-methylpyrrolidone were admixed with the above mixture to obtain a slurry for an auxiliary layer.

The slurry of the composition for cathodes and the slurry for the auxiliary layer were coated, respectively, at a lower layer and at an upper layer, using an extrusion coater on a copper foil having a thickness of 10 μm, and after drying, the resultant foil was press molded using a calendar press to obtain a cathode sheet having a thickness of 46 μm, a width of 55 mm and a length of 50 mm. After a nickel leading plate was welded to an end of the cathode sheet, heat treatment was performed at 230° C. for 1 hour in dry air having a dew point of −40° C. or lower. The heat treatment was conducted using a far infrared heater. Onto the entire surface of the thus heat-treated cathode sheet, lithium foils (purity 99.8%) having a thickness of 35 μm and cut into a size of 4 mm×55 mm were adhered perpendicularly to the longitudinal direction of the sheet with a pitch of 10 mm (AN-1).

(Preparation of cathode sheet <2>)

The same procedure was conducted as in the preparation of the cathode sheet <1> above, except that SnSiO₃ was replaced with Sn_{0.8}Al_{0.2}B_{0.3}P_{0.2}Si_{0.5}O_{3.6} or SnAl0.4B_{0.5}Cs_{0.1}P_{0.5}O_{3.65} to thereby obtain a cathode sheet (AN-2) or (AN-3) having a width of 55 mm and a length of 50 mm, with a nickel leading plate welded to an end of the sheet and lithium foils adhered thereto.

(Preparation of cathode sheet <3>)

43 parts by weight of mesophase pitch carbon material (manufactured by Petca Co.) as the cathode active material were mixed with 2 parts by weight of acetylene black and 2 parts by weight of graphite as the electrically conductive material, to which were added 3 parts by weight of polyacrylonitrile as the binder and 100 parts by weight of N-methylpyrrolidone as the solvent, and the resultant mixture was kneaded to obtain a slurry of the composition for cathodes.

The slurry of the composition for cathodes was coated using an extrusion coater on a copper foil having a thickness of 10 μm, and after drying, the resultant foil was press molded using a calendar press to obtain a cathode sheet having a thickness of 46 μm, a width of 55 mm and a length of 50 mm. After a nickel leading plate was welded to an end of the cathode sheet, heat treatment was conducted at 230° C. for 1 hour in dry air having a dew point of −40° C. or lower. The heat treatment was performed using a far infrared heater (AN-4).

(Production of sheet-shaped battery <1>)

The cathode sheet and the anode sheet were respectively dried and dehydrated at 230° C. for 30 minutes, in dry air having a dew point of −40° C. or lower. In a dry atmosphere, the dehydrated anode sheet (CA-1) (21) having a width of 54 mm and a length of 49 mm, a non-woven cloth TAPYRUS P22FW—OCS (22) having a thickness of 30 μm (manufactured by Tonen Tapyrus Co., Ltd.) and cut into a size of a width of 60 mm and a length of 60 mm and the dehydrated cathode sheet (AN-1) (23) having a width of 55 mm and a length of 50 mm were layered successively, and the electrolyte E-1 was poured thereinto at 70° C. under reduced pressure. Subsequently, an outer wrapping material that was a polyethylene (50 μm)/polyethylene terephthalate (50 μm) laminate film was applied on the resultant product and then sealed at four sides by fusion in vacuum, to finally produce a sheet-shaped battery (Example 19). The sheet-shaped batteries of Examples 20 to 28 and Comparative Examples 4 to 9 were produced in a similar manner, that had configurations shown in Table 5 below.

TABLE 5

| | Anode | Cathode | | Relative | Cycle |
|---|---|---|---|---|---|
| Battery No. | Sheet | Sheet | Electrolyte | Capacity | Capacity |
| Example 19 | CA-1 | AN-1 | E-1 | 1 | 0.91 |
| Example 20 | CA-1 | AN-1 | E-3 | 1.18 | 0.90 |
| Example 21 | CA-1 | AN-1 | E-5 | 1.09 | 0.88 |
| Example 22 | CA-1 | AN-1 | E-9 | 1.10 | 0.89 |
| Example 23 | CA-1 | AN-1 | E-13 | 2.87 | 0.88 |
| Example 24 | CA-1 | AN-2 | E-3 | 1 | 0.91 |
| Example 25 | CA-1 | AN-3 | E-3 | 1 | 0.91 |
| Example 26 | CA-1 | AN-4 | E-3 | 1 | 0.90 |
| Example 27 | CA-2 | AN-1 | E-3 | 1 | 0.89 |
| Example 28 | CA-3 | AN-1 | E-3 | 1 | 0.91 |
| Comp.Ex.4 | CA-1 | AN-1 | E-16 | 0.81 | 0.82 |
| Comp.Ex.5 | CA-1 | AN-2 | E-16 | 0.80 | 0.81 |
| Comp.Ex.6 | CA-1 | AN-3 | E-16 | 0.78 | 0.82 |
| Comp.Ex.7 | CA-1 | AN-4 | E-16 | 0.74 | 0.81 |
| Comp.Ex.8 | CA-2 | AN-1 | E-16 | 0.81 | 0.72 |
| Comp.Ex.9 | CA-3 | AN-1 | E-16 | 0.82 | 0.81 |

(Evaluation of battery performance)

Each of the sheet-shaped batteries produced by the above process was subjected to 10 cycles of charging and discharging under conditions of 0.2 C, a charging end voltage of 4.2 V and a discharging end voltage of 2.6 V, and measured for a discharging capacity at the tenth cycle. The capacities obtained in ten batteries having the same formulation were averaged to define the capacity of such batteries. The capacity of each of the batteries was determined, and a relative capacity for the same electrode formulation was determined by dividing this value by the values of Examples 20 to 23 and dividing the value of Comparative Example 4 by the value of Example 19, dividing the value of Comparative Example 5 by the value of Example 24, dividing the value of Comparative Example 6 by the value of Example 25, dividing the value of Comparative Example 7 by the value of Example 26, dividing the value of Comparative Example 8 by the value of Example 27, and diving the value of Comparative Example 9 by the value of Example 28. Also in each of the batteries, the discharging capacities at the 300th cycle at 0.5 C (charging end voltage 4.2 V, discharging end voltage 2.6 V) was measured, and a cycle capacity was determined by calculating a ratio of the above capacity to the discharging capacity at the 10th cycle. The obtained results are shown in Table 5 above.

These results indicate that the electrolyte prepared using the specified compound of the present invention improved the cycle characteristics without deteriorating the capacity.

(Production of sheet-shaped battery <2>)

The cathode sheet and the anode sheet were respectively dried and dehydrated at 230° C. for 30 minutes, in dry air having a dew point of −40° C. or lower. In a dry atmosphere, the dehydrated anode sheet (CA-1) (21) having a width of 54 mm and a length of 49 mm, a solid electrolyte thin film (22) cut into a size of a width of 60 mm and a length of 60 mm, and the dehydrated cathode sheet (AN-1) (23) having a width of 55 mm and a length of 50 mm were layered successively, and an outer wrapping material that was a polyethylene (50 μm)/polyethylene terephthalate (50 μm) laminate film was applied on the resultant product and then sealed at four sides by fusion in vacuum, to finally produce a sheet-shaped battery (Example 39). The sheet-shaped batteries of Examples 29 to 40 and Comparative Examples 10 to 15 were produced in a similar manner, that had configurations shown in Table 6 below.

TABLE 6

| | Anode | Cathode | Solid | Relative |
|---|---|---|---|---|
| Battery No. | Sheet | Sheet | Electrolyte | Capacity |
| Example 29 | CA-1 | AN-1 | SPE-2 | 1.0 |
| Example 30 | CA-1 | AN-1 | SPE-5 | 0.97 |
| Example 31 | CA-1 | AN-1 | SPE-7 | 0.92 |
| Example 32 | CA-1 | AN-1 | SPE-8 | 0.92 |
| Example 33 | CA-1 | AN-1 | SPE-9 | 0.92 |
| Example 34 | CA-1 | AN-1 | SPE-10 | 0.91 |
| Example 35 | CA-1 | AN-1 | SPE-11 | 0.80 |
| Example 36 | CA-1 | AN-2 | SPE-2 | 1.0 |
| Example 37 | CA-1 | AN-3 | SPE-2 | 1.0 |
| Example 38 | CA-1 | AN-4 | SPE-2 | 1.0 |
| Example 39 | CA-2 | AN-1 | SPE-2 | 1.0 |
| Example 40 | CA-3 | AN-1 | SPE-2 | 1.0 |
| Comp.Ex.10 | CA-1 | AN-1 | SPE-12 | 0.22 |
| Comp.Ex.11 | CA-1 | AN-2 | SPE-12 | 0.21 |
| Comp.Ex.12 | CA-1 | AN-3 | SPE-12 | 0.21 |
| Comp.Ex.13 | CA-1 | AN-4 | SPE-12 | 0.20 |
| Comp.Ex.14 | CA-2 | AN-1 | SPE-12 | 0.23 |
| Comp.Ex.15 | CA-3 | AN-1 | SPE-12 | 0.22 |

(Evaluation of battery performance)

Each of the sheet-shaped batteries produced by the above process was subjected to 10 cycles of charging and discharging under conditions of 0.2 C, a charging end voltage of 4.2 V and a discharging end voltage of 2.6 V, and assessed for a discharging capacity at the tenth cycle. The capacities obtained in ten batteries having the same formulation were averaged to define the capacity of such batteries. The capacity of each of the batteries was determined, and a relative capacity for the same electrode formulation was determined by dividing this value by the values of Examples 30 to 35 and dividing the value of Comparative Example 10 by the value of Example 29, dividing the value of Comparative Example 11 by the value of Example 36, dividing the value of Comparative Example 12 by the value of Example 37, dividing the value of Comparative Example 13 by the value of Example 38, dividing the value of Comparative Example 14 by the value of Example 39, and dividing the value of Comparative Example 15 by the value of Example 40. The obtained results are shown in Table 6.

These results indicate that electrode prepared using the specific compound of the present invention provided a larger battery capacity as compared to Comparative Examples that employed conventional solid electrolytes.

As detailed above, the electrolytic composition of the present invention exhibits a high ionic conductivity and a large ion transport number. The non-aqueous electrolytic secondary battery of the invention produced using the electrolytic composition has an excellent durability and improves the cycle stability without deteriorating the capacity, that is sufficient to be applied for a lithium secondary battery.

What is claimed is:

1. An electrolytic composition comprising a silicon polymer, inorganic fine particles and a metal ion salt of the 1st or 2nd group of the periodic table.

2. The electrolytic composition according to claim 1, wherein the silicon polymer includes, as the repeating unit, a structure represented by the following general formula (1): 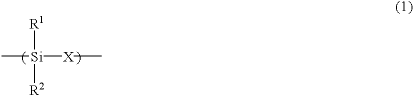
wherein R¹ and R² each represent an optionally substituted alkyl, alkoxy, aryl or aryloxy group; and X represents an oxygen atom, a nitrogen atom, an alkylene group, a phenylene group, a silicon atom, a metal atom or an atomic group in combination thereof.

3. The electrolytic composition according to claim 2, wherein R² in the general formula (1) is an optionally substituted alkoxy or aryloxy group; and X is an oxygen atom.

4. The electrolytic composition according to claim 2, wherein R¹ in the general formula (1) is an optionally substituted alkoxy group.

5. The electrolytic composition according to claim 3, wherein R² has an alkoxycarbonyl group as the substituent.

6. The electrolytic composition according to claim 3, wherein R¹ has an alkoxycarbonyl group as the substituent.

7. The electrolytic composition according to claim 1, wherein the inorganic fine particles are selected from the group consisting of silica (silicon oxide), aluminum oxide, zinc oxide, magnesium oxide and titanium oxide.

8. The electrolytic composition according to claim 7, wherein a primary average particle size of the inorganic fine particles is no more than 500 nm.

9. The electrolytic composition according to claim 1, wherein the inorganic fine particles are added in an amount of 0.1 to 100% by mass relative to the silicon polymer.

10. The electrolytic composition according to claim 1, wherein the metal ion salt is selected from the group consisting of LiCF₃SO₃, LiPF₆, LiClO₄, LiI, LiBF₄, LiCF₃CO₂, LiSCN, LiN(SO₂CF₃)₂, NaI, NaCF₃SO₃, NaClO₄, NaBF₄, NaAsF₆, KCF₃SO₃, KSCN, KPF₆, KClO₄ and KAsF₆.

11. The electrolytic composition according to claim 1, wherein the metal ion salt is added in an amount of 1 to 300% by mass relative to the silicon polymer.

12. A non-aqueous electrolytic secondary battery including an anode and a cathode, and comprising an electrolytic composition containing a silicon polymer, inorganic fine particles and a metal ion salt of the 1st or 2nd group of the periodic table.

13. The non-aqueous electrolytic secondary battery according to claim 12, wherein the silicon polymer includes, as the repeating unit, a structure represented by the following general formula (1): 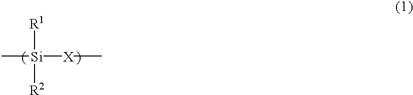
wherein R¹ and R² each represent an optionally substituted alkyl, alkoxy, aryl or aryloxy group; and X represents an oxygen atom, a nitrogen atom, an alkylene group, a phenylene group, a silicon atom, a metal atom or an atomic group in combination thereof.

14. The non-aqueous electrolytic secondary battery according to claim 12, wherein the anode is prepared by coating a composition for electrodes containing an anode active material on a sheet-shaped current collecting member made of aluminum or an aluminum alloy, followed by drying and compressing.

15. The non-aqueous electrolytic secondary battery according to claim 14, wherein the anode active material is an oxide of a lithium-containing transition metal.

16. The non-aqueous electrolytic secondary battery according to claim 15, wherein the oxide of a lithium-containing transition metal is selected from the group consisting of Li_{g}CoO₂, Li_{g}NiO₂, Li_{g}MnO₂, Li_{g}CoⱼNi₁₋ⱼO₂ and LiₕMn₂O₄ in which g=0.02 to 1.2; j=0.1 to 0.9; and h=0 to 2.

17. The non-aqueous electrolytic secondary battery according to claim 16, wherein an average particle size of the anode active material is 0.1 to 50 μm.

18. The non-aqueous electrolytic secondary battery according to claim 12, wherein the cathode is prepared by coating a composition for electrodes containing a cathode active material on a sheet-shaped current collecting member made of copper or a copper alloy, followed by drying and compressing.

19. The non-aqueous electrolytic secondary battery according to claim 18, wherein the cathode active material is a carbon material selected from the group consisting of petroleum pitch, natural graphite, artificial graphite, a sintered product of a PAN resin, a sintered product of a furfuryl alcohol resin and carbon fibers.

20. The non-aqueous electrolytic secondary battery according to claim 18, wherein the cathode active material is at least one of an amorphous oxide of a semi-metal element and a chalcogenide.
